(19) United States
(12) Patent Application Publication
(10) Pub. No.: US 2010/0328013 A1
(43) Pub. Date: Dec. 30, 2010

(54) TRANSFORMER

(75) Inventors: Hee Soo KIM, Yongin (KR); Yong Ju OH, Hwaseong (KR); Soo Deok Moon, Suwon (KR); Dong Jin KIM, Gwangmyeong (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/648,215

(22) Filed: Dec. 28, 2009

(30) Foreign Application Priority Data
Jun. 30, 2009 (KR) 10-2009-0059188

(51) Int. Cl. H01F 17/04

(52) U.S. Cl. 336/221

(57) ABSTRACT

There is provided a transformer including cores combined with a bobbin wound with coils, and center leg parts extended from the cores and contacting each other by being inserted into both ends of the bobbin, wherein stress dispersion hole, dispersing stress occurring according to temperature variations around the cores, is formed at the edge of center leg connection parts of the cores from which the center leg parts are extended.

### CROSS-REFERENCE TO RELATED APPLICATIONS

This application claims the priority of Korean Patent Application No. 10-2009-0059188 filed on Jun. 30, 2009, in the Korean Intellectual Property Office, the disclosure of which is incorporated herein by reference.

### BACKGROUND OF THE INVENTION

1. Field of the Invention

The present invention relates to a transformer, and more particularly, to a transformer for preventing cracks from occurring in a center leg connection part extended from a core.

2. Description of the Related Art

A transformer is a device that varies an alternating voltage and a current value using electromagnetic induction, and it is an indispensable element of electronic devices. The transformer is manufactured by winding coils surrounding a large magnetic core. A first coil is connected to an input circuit serving to vary a voltage and a second coil is connected to an output circuit serving to use the varied voltage.

In general, a transformer includes cores whose center leg parts are in contact with each other and are combined by a bonding process using an adhesive, and a bobbin enclosing the center leg parts and wound with coils.

Since the cores composed of ferrite materials are brittle, they are susceptible to mechanical shock. Particularly, cracks may easily occur due to thermal shock caused by rapid temperature variations during repeated heating and cooling.

The adhesive bonding between the center leg parts plays an important role in preventing vibration and noise occurring when the transformer operates. However, due to a large difference in thermal expansion coefficients between the cores and the adhesive, the expansion or contraction of the adhesive is greater than that of the cores during heating or cooling. Accordingly, considerable thermal stress occurs in the cores, and thus cracks occur at the edges of the connection parts between the center leg parts and the cores.

### SUMMARY OF THE INVENTION

An aspect of the present invention provides a transformer addressing a stress concentration phenomenon occurring in center leg connection parts by forming stress dispersion hole at the edges of the center leg connection parts of cores where stress is concentrated.

According to an aspect of the present invention, there is provided a transformer including cores combined with a bobbin wound with coils, and center leg parts extended from the cores and contacting each other by being inserted into both ends of the bobbin, wherein stress dispersion hole, dispersing stress occurring according to temperature variations around the cores, is formed at an edge of center leg connection parts of the cores from which the center leg parts are extended.

The stress dispersion hole may be formed to have the same radius inward the cores and the center leg parts at the edge of the center leg connection parts.

The stress dispersion hole may be formed inward the center leg parts.

The stress dispersion hole may be formed inward the cores.

The cores may be sintered bodies, and the stress dispersion hole may be formed by drilling through the sintered bodies.

The cores may be sintered bodies, and the cores may be subject to a compression sintering process by placing ferrite powder in a mold with which to form the stress dispersion hole.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of a transformer according to an exemplary embodiment of the present invention;

FIG. 2 is an exploded perspective view of a transformer according to an exemplary embodiment of the present invention;

FIG. 3 is a cross-sectional view of a transformer according to an exemplary embodiment of the present invention;

FIGS. 4A through 4C schematically illustrate the shapes of a stress dispersion hole formed in a core of a transformer according to an exemplary embodiment of the present invention;

FIG. 5 is a schematic plan view illustrating the thermal expansion of cores when a thermal shock test is applied to a transformer according to an exemplary embodiment of the present invention;

FIG. 6 is a graph illustrating a stress range according to the shapes of the stress dispersion hole formed in the core of FIGS. 4A through 4C by comparison with the related art example having no stress dispersion hole; and

FIG. 7 is a graph illustrating crack resistance according to the shapes of the stress dispersion hole formed in the core of FIGS. 4A through 4C by comparison with the related art example having no stress dispersion hole.

### DETAILED DESCRIPTION OF THE PREFERRED EMBODIMENT

Exemplary embodiments of the present invention will now be described in detail with reference to the accompanying drawings.

Also, throughout the drawings, the same reference numerals will be used to designate the same or like parts.

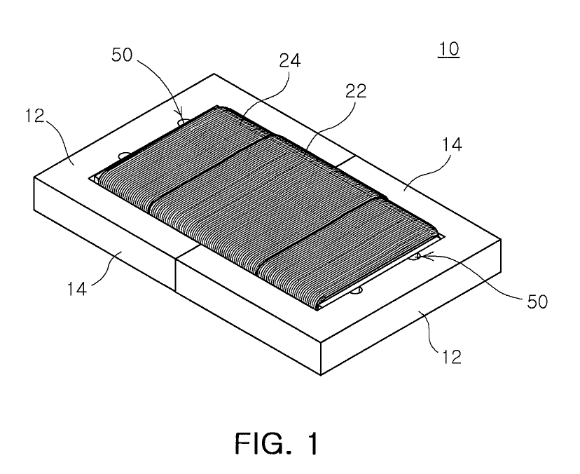

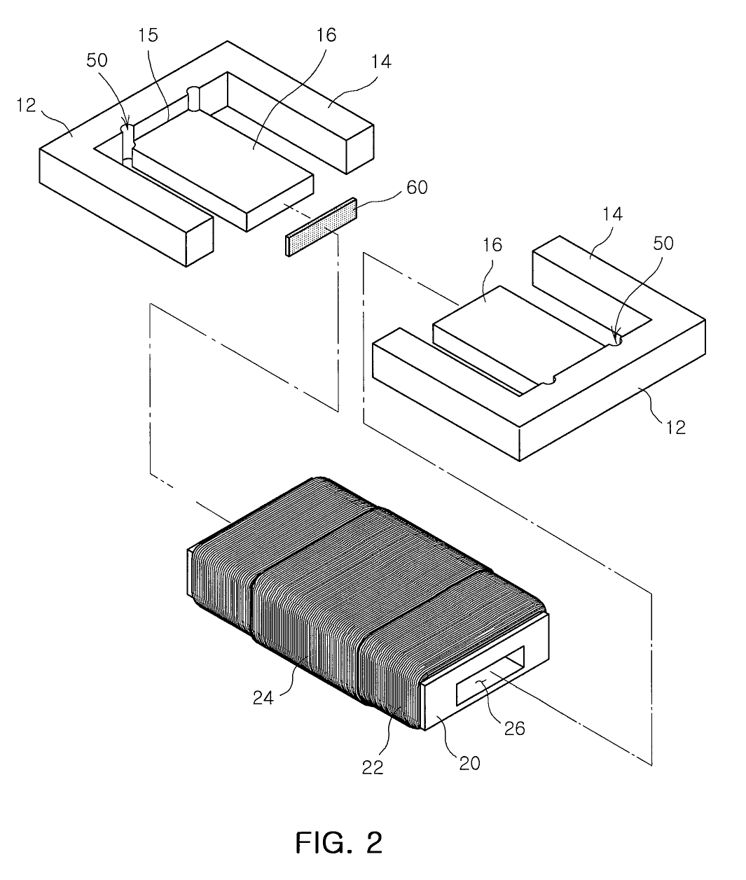

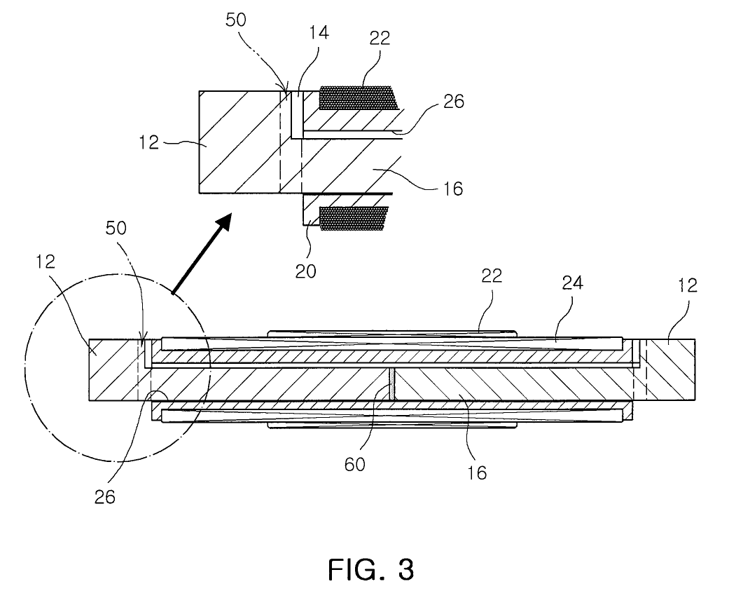

FIG. 1 is a schematic perspective view of a transformer according to an exemplary embodiment of the present invention. FIG. 2 is an exploded perspective view of a transformer according to an exemplary embodiment of the present invention. FIG. 3 is a cross-sectional view of a transformer according to an exemplary embodiment of the present invention.

A transformer 10 according to an exemplary embodiment of the invention includes cores 12 and center leg parts 16.

The cores 12 may be combined with a bobbin 20 wound with coils 22 and 24. The bobbin 20 may have a rectangular cross section. Inside the bobbin 20, a center leg insertion hole 26, in which the center leg parts 16 can be inserted, may be formed. A first coil 22 may be wound on an outer surface of the bobbin 20 and a second coil 24 may be wound on an outer surface of the first coil 22.

The winding and arrangement of the first and second coils 22 and 24 may be variable according to the selection of a person having ordinary skill in the art.

The cores 12 are sintered bodies manufactured by a sintering process of ferrite material powder, and they have an “E” shape. That is, the cores 12 have outer leg parts 14 at the respective edges thereof and the center leg parts 16 are formed between the outer leg parts 14.

The transformer 10 may allow the center leg parts 16 of the cores 12 to contact each other by being inserted into both ends of the center leg insertion hole 26 of the bobbin 20. At this time, the center leg parts 16 may be adhesively fixed to each other by using an adhesive 60.

Stress dispersion holes 50 may be formed at the edges of center leg connection parts 15 from which the center leg parts 16 of the cores 12 are extended. The stress dispersion holes disperse stress occurring according to temperature variations around the cores.

Here, the center leg parts 16 inserted into both ends of the bobbin 20 may be combined by the adhesive 60. Here, the thermal expansion coefficients of the adhesive 60 and the cores 12 are 5×10⁻⁵/K and 1.23×10⁻⁷/K, respectively. That is, the thermal expansion coefficient of the adhesive 60 is greater than that of the cores 12. For this reason, if the transformer 10 is cooled, the adhesive 60 undergoes a greater contraction than the cores 12, and therefore, stress is concentrated on the edges of the center leg connection parts 15.

In this embodiment, the stress dispersion holes 50 are formed at the edges of the center leg connection parts 15, thereby preventing stress concentration.

The stress dispersion holes 50 may be formed by a drilling process. Also, the cores 12 may be manufactured in a compression sintering process by placing ferrite powder in a mold (not shown), in which the stress dispersion holes 50 are formed, at an initial stage of sintering.

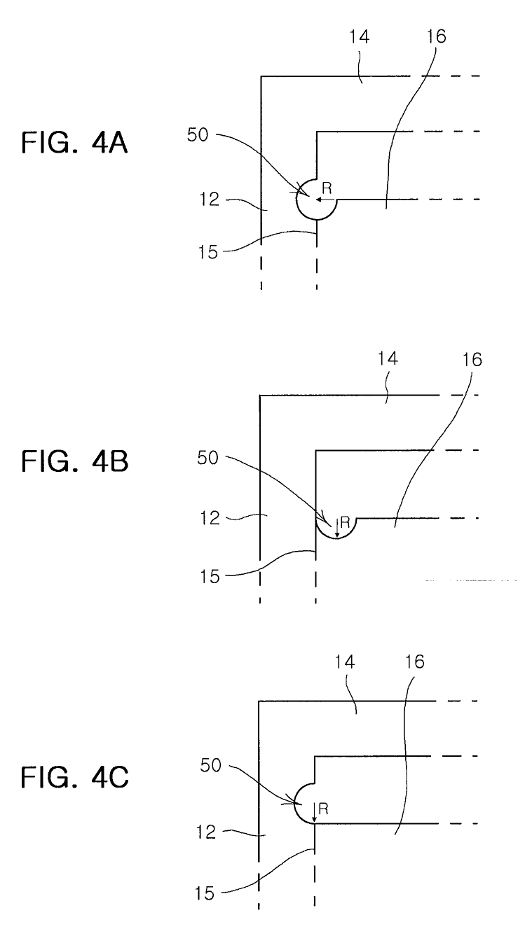

FIGS. 4A through 4C schematically illustrate the shapes of a stress dispersion hole formed in a core of a transformer according to an exemplary embodiment of the present invention.

FIG. 4A illustrates an example 1 in which the stress dispersion hole 50 is formed to have the same radius inward the core 12 and the center leg part 16 at the edge of the center leg connection part 15. FIG. 4B illustrates an example 2 in which the stress dispersion hole 50 is formed inward the center leg part 16. FIG. 4C illustrates an example 3 in which the stress dispersion hole 50 is formed inward the core 12.

These examples 1, 2 and 3, together with a related art example having no stress dispersion hole around the edge of the center leg connection part 15, were subject to a simulation of stress caused by a difference in thermal expansion coefficients between the core 12 and the adhesive 60.

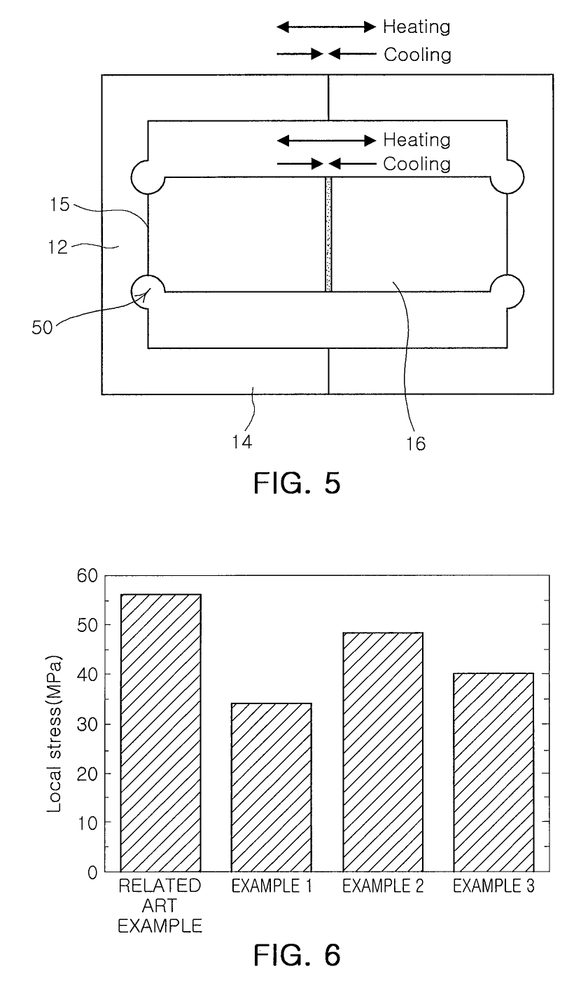

FIG. 5 is a schematic plan view illustrating the thermal expansion of cores when a thermal shock test is applied to a transformer according to an exemplary embodiment of the present invention.

Referring to FIG. 5, when the temperature of the adhesive 60 and the cores 12 was rapidly changed, that is, rapid heating and cooling were continuously repeated (defined as the thermal shock test), the action of force could be viewed.

When the adhesive 60 is heated, it undergoes a greater expansion than the cores 12, so it pushes the center leg parts 16 outwards. When the adhesive 60 is cooled, it undergoes a greater contraction than the cores 12, so it pulls the center leg parts 16 inwards.

Here, the conditions of the thermal shock test were controlled such that the radius R of the stress dispersion holes was 1.5 mm and the transformer cooling and heating temperatures and times were continuously changed between 30 minutes at 85° C. and 30 minutes at −40° C. (a cycle is defined as a single cooling duration and a single heating duration evenly applied during a one hour period).

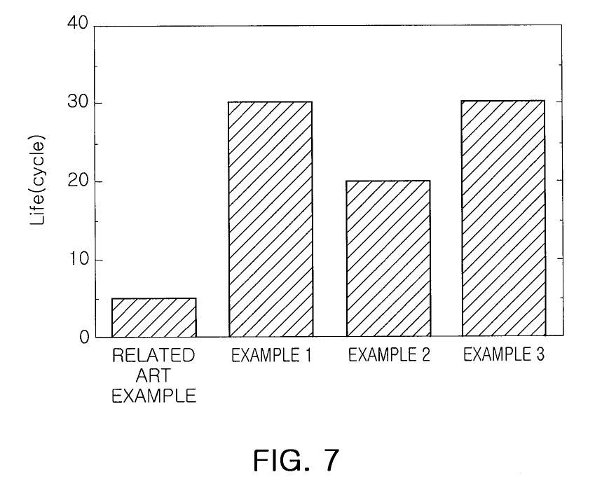

A maximum stress and a crack occurrence cycle demonstrated through such a thermal shock test are shown in FIGS. 6 and 7, respectively.

FIG. 6 is a graph illustrating a stress range according to the shapes of the stress dispersion hole formed in the core of FIGS. 4A through 4C by comparison with the related art example having no stress dispersion hole. FIG. 7 is a graph illustrating crack resistance according to the shapes of the stress dispersion hole formed in the core of FIGS. 4A through 4C by comparison with the related art example having no stress dispersion hole.

Referring to FIG. 6, the maximum stresses of the examples 1, 2, and 3 were reduced by 29%, 14% and 28%, respectively, as compared to the related art example. Referring to FIG. 7, during the thermal shock test, in the case of the related art example, cracks occurred in a fifth cycle; whereas in the case of the examples 1, 2 and 3, cracks occurred in thirtieth, twentieth and thirtieth cycles, respectively.

In conclusion, all the three examples presented in the present invention showed superior stress dispersion and a remarkable crack prevention effect as compared to the existing related method through the simulation tests.

As set forth above, according to exemplary embodiments of the invention, the transformer has the stress dispersion hole at the edges of the center leg connection parts of the cores where stress is concentrated, thereby relieving a stress concentration phenomenon and improving a crack prevention effect.

While the present invention has been shown and described in connection with the exemplary embodiments, it will be apparent to those skilled in the art that modifications and variations can be made without departing from the spirit and scope of the invention as defined by the appended claims.

What is claimed is:

1. A transformer comprising:
cores combined with a bobbin wound with coils; and
center leg parts extended from the cores and contacting each other by being inserted into both ends of the bobbin,
wherein a stress dispersion hole, dispersing stress occurring according to temperature variations around the cores, is formed at an edge of center leg connection parts of the cores from which the center leg parts are extended.

2. The transformer of claim 1, wherein the stress dispersion hole is formed to have the same radius inward the cores and the center leg parts at the edge of the center leg connection parts.

3. The transformer of claim 1, wherein the stress dispersion hole is formed inward the center leg parts.

4. The transformer of claim 1, wherein the stress dispersion hole is formed inward the cores.

5. The transformer of claim 1, wherein the cores are sintered bodies,
the stress dispersion hole is formed by drilling through the sintered bodies.

6. The transformer of claim 1, wherein the cores are sintered bodies,
the cores are subject to a compression sintering process by placing ferrite powder in a mold with which to form the stress dispersion hole.
